(19) United States
(12) Patent Application Publication
(10) Pub. No.: US 2014/0142210 A1
(43) Pub. Date: May 22, 2014

(54) ADHESIVE COMPOSITION

(71) Applicants: Henkel US IP LLC, Rocky Hill, CT (US); Henkel (China) Company Limited, Shanghai (CN)

(72) Inventors: Raymond Zhang, Shanghai (CN); Daoqiang Lu, Chandler, AZ (US); Shabbir Attarwala, Simsbury, CT (US)

(21) Appl. No.: 14/162,301

(22) Filed: Jan. 23, 2014

Related U.S. Application Data
(63) Continuation of application No. PCT/CN2012/078934, filed on Jul. 20, 2012.

(30) Foreign Application Priority Data
Jul. 25, 2011 (CN) 201110211101.X

(51) Int. Cl. C09J 133/14

(52) U.S. Cl. CPC C09J 133/14
USPC 522/8; 522/179; 526/320

(57) ABSTRACT

The present invention relates to an adhesive composition, which comprises, based on the total weight of the adhesive composition:

(1) from 38.0 to 75.0 percent by weight of a urethane oligomer carrying (meth)acryloyloxy group; (2) from 0.1 to 10.0 percent by weight of a multifunctional (meth)acrylate monomer; (3) from 15.0 to 60.0 percent by weight of a monofunctional (meth)acrylate monomer; (4) from 0.5 to 5.0 percent by weight of a photoinitiator; (5) from 0.1 to 5.0 percent by weight of a silane coupling agent; and (6) from 0 to 5.0 percent by weight of an additive, which is selected from one or more of the group consisting of a tackifier, a thickening agent, a flame retardant, a leveling agent and a thermal initiator. The cured adhesive composition has a high transparency and a high bonding strength, and the adhesive composition can be used for bonding various substrates in display devices.

### FIELD OF THE INVENTION

The present invention relates to an adhesive composition, which can be used for bonding various substrates in display devices.

### BACKGROUND ART

With the development of display devices, such as touch panels, new adhesives that can be used in those display devices are highly demanded. The adhesives should fulfill different requirements, e.g. the adhesive should be easily applied, easily cured, and should have a good transparency and good adhesion. Currently, the adhesives used for touch panels mostly are adhesive tapes. However, the optical transparency of adhesive tapes is not good. Thus, liquid adhesives for touch panels are developed to replace the adhesive tapes.

US 2010/0003425 A1 discloses a method of producing an image display device, comprising the step of forming a cured resin layer by interposing a photo-curable resin composition between an image display unit and a light-transmitting protection member, wherein the resin composition contains a polymer selected from the group consisting of a polyurethane acrylate, a polyisoprene acrylate, and a terpene resin etc.

WO 2010/111316 A2 discloses an optical assembly having a display panel and methods of making and disassembling the same. WO 2010/111316 A2 uses an adhesive layer to bond a display panel and a substantially transparent substrate, wherein the adhesive layer comprises the reaction product of a multifunctional urethane(meth)acrylate oligomer and a reactive diluent comprising a monofunctional (meth)acrylate monomer, and an oil.

The adhesives disclosed in the above-mentioned prior art references have common defects, for example, the bonding effects between uneven surfaces of substrates are unsatisfying, the transparency is not high or the bonding strength is not strong enough.

Consequently, it is necessary to develop an adhesive composition, which has a high transparency and a high bonding strength after being cured, wherein the adhesion does not fail or bubbles do not occur in the adhesive composition even under severe conditions, such as in the large temperature range of −40 to 70° C. and under high humidity conditions, and thus the performances of the adhesive and the final product are improved.

### SUMMARY OF THE INVENTION

The present invention provides an adhesive composition, which can be cured by UV irradiation, and the cured adhesive has a very high bonding strength, a very high flexibility and a very high elongation at break, and the parts adhered with the adhesive have excellent performance of preventing the occurrence of cracks under aging conditions.

The adhesive composition of the present invention comprises, based on the total weight of the adhesive composition:

(1) from 38.0 to 75.0 percent by weight of a urethane oligomer carrying (meth)acryloyloxy group;

(2) from 0.1 to 10.0 percent by weight of a multifunctional (meth)acrylate monomer;

(3) from 15.0 to 60.0 percent by weight of a monofunctional (meth)acrylate monomer;

(4) from 0.5 to 5.0 percent by weight of a photoinitiator;

(5) from 0.1 to 5.0 percent by weight of a silane coupling agent; and

(6) optional an additive selected from one or more of the group consisting of a tackifier, a thickening agent, a flame retardant, a leveling agent and a thermal initiator.

In another aspect the present invention relates to the cured product of the adhesive of the present invention and to display devices which comprise said cured product.

In further aspects the present invention relates to the use of the adhesive of the present invention for bonding or laminating parts in display devices and to the use of said adhesive for assembling transparent parts.

### DETAILED DESCRIPTION OF THE INVENTION

All technical terms and scientific terms used herein have the same meanings as those commonly understood by those skilled in the art, unless indicated otherwise. In case that the meanings understood by those skilled in the art conflict with the meanings defined herein, the meanings defined herein shall be used as the criterion.

All percentages, parts, proportions and the like mentioned herein are based on weight.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context. The numerical ranges mentioned herein are meant to include both end values of the ranges and also all integers or fractions included in the ranges, unless indicated otherwise.

Each component of the adhesive composition of the invention will be described as follows.

### Urethane Oligomer Carrying (Meth)Acryloyloxy Group

The urethane oligomer carrying (meth)acryloyloxy group is a urethane oligomer carrying one or more (meth)acryloyloxy group(s).

The term “(meth)acryloyloxy”, as used herein, refers to both acryloyloxy and methacryloyloxy.

The average functionality of the urethane oligomer carrying (meth)acryloyloxy group is ≦2. The term “average functionality”, as used herein, means the average number of the (meth)acryloyloxy group(s) per molecule of the oligomer.

The urethane oligomer carrying (meth)acryloyloxy group preferably has a glass transition temperature (Tg) of from −80° C. to 0° C., more preferably from −60° C. to 0° C.

The urethane oligomer carrying (meth)acryloyloxy group preferably has a Brookfield viscosity of from 1000 mPa·s to 190000 mPa·s at 25° C., more preferably from 2000 mPa·s to 150000 mPa·s.

The amount of the urethane oligomer carrying (meth)acryloyloxy group in the adhesive composition of the present invention is from 38.0 to 75.0 percent by weight, preferably, from 40.0 to 65.0 percent by weight.

### (Meth)Acrylate Monomer

The (meth)acrylate monomer includes monofunctional (meth)acrylate monomers and multifunctional (meth)acrylate monomers.

The term “(meth)acrylate”, as used herein, refers to both acrylate and methacrylate.

The monofunctional (meth)acrylate monomer can be selected from monofunctional alkyl(meth)acrylates, monofunctional alkenyl(meth)acrylates, and monofunctional heterocyclo(meth)acrylates, wherein said alkyl is an alkyl group having from 1 to 20 carbon atoms, which may have one or more substituents; said alkenyl is an alkenyl group having from 2 to 20 carbon atoms, which may have one or more substituents; and said heterocyclo is a heterocyclic group having from 2 to 20 carbon atoms and having a heteroatom selected from nitrogen and oxygen, which may have one or more substituents; said one or more substituents may be selected from an alkyl group having from 1 to 20 carbon atoms, an alkyloxy group having from 1 to 20 carbon atoms, an aryloxy group having from 6 to 20 carbon atoms, a cyclalkyloxy group having from 3 to 20 carbon atoms, and hydroxyl.

The multifunctional (meth)acrylate monomer can be selected from multifunctional alkyl(meth)acrylates, multifunctional alkenyl(meth)acrylates, and multifunctional heterocyclo(meth)acrylates, wherein said alkyl is an alkyl group having from 1 to 20 carbon atoms, which may have one or more substituents; said alkenyl is an alkenyl group having from 2 to 20 carbon atoms, which may have one or more substituents; and said heterocyclo is a heterocyclic group having from 2 to 20 carbon atoms and having a heteroatom selected from nitrogen and oxygen, which may have one or more substituents; said one or more substituents may be selected from an alkyl group having from 1 to 20 carbon atoms, an alkyloxy group having from 1 to 20 carbon atoms, an aryloxy group having from 6 to 20 carbon atoms, a cycloalkyloxy group having from 3 to 20 carbon atoms, and hydroxyl.

Representative examples of the (meth)acrylate monomer include methyl(meth)acrylate, ethyl(meth)acrylate, butyl(meth)acrylate, 2-(2-ethoxyethoxy) ethyl acrylate, tetrahydrofurfury(meth)acrylate, lauryl acrylate, isooctyl acrylate, isodecyl acrylate, 2-phenoxyethyl acrylate, 2-ethylhexyl(meth)acrylate, isobornyl(meth)acrylate, dicyclopentenyloxyethyl(meth)acrylate, dicyclopentadienyl(meth)acrylate, 2-hydroxyethyl(meth)acrylate, 2-hydroxypropyl(meth)acrylate, 2-hydroxybutyl(meth)acrylate, caprolactone acrylate, morpholine(meth)acrylate, hexanediol di(meth)acrylate, ethyleneglycol dimethacrylate, trimethylolpropane triacrylate, pentaerythritol tetraacrylate and combinations thereof.

In the adhesive composition of the present invention, the monofunctional (meth)acrylate monomer or the multifunctional (meth)acrylate monomer can be used alone, or used in any combination thereof.

The amount of the monofunctional (meth)acrylate monomer in the adhesive composition of the present invention is from 15.0 to 60.0 percent by weight, preferably, from 20.0 to 45.0 percent by weight, and the amount of the multifunctional (meth)acrylate monomer is from 0.1 to 10.0 percent by weight, preferably, from 2.0 to 8.0 percent by weight.

### Photoinitiator

There is no special limitation on the photoinitiators in the present invention. The photoinitiators generally used are benzil ketals, hydroxy ketones, amino ketones and acyl phosphine peroxides. Suitable photoinitiators include but are not limited to 2,2-dimethoxy-1,2-diphenylethan-1-one, trimethylbenzoyl diphenylphosphine oxide, 1-hydroxycyclohexyl benzophenone, 2-methyl-1-[4-(methylthio)phenyl]-2-morpholinopropan-1-one, ethyl-2,4,6-trimethylbenzoylphenylphosphinate, 2-hydroxyl-2-methyl-1-phenyl-1-propanone, diphenyl(2,4,6-trimethylbenzoyl)-phosphine oxide and combinations thereof. In the examples of the present invention, the photoinitiators of hydroxy ketones and acyl phosphine oxides are used as the photoinitiators. One or more initiators can be used in the adhesive of the present invention.

The amount of the photoinitiator in the adhesive composition of the present invention is from 0.5 to 5.0 percent by weight, preferably from 2.0 to 4.0 percent by weight.

### Silane Coupling Agent

The silane coupling agent is a liquid silane having an organic group, wherein more than one alkoxy group is bonded to the silicon atom at one end of the molecule. The silane coupling agent can react with the surface of inorganic materials. The silane coupling agent further comprises a reactive group at the other end of the molecule which can chemically interact with a resin, e.g., a vinyl resin, an epoxy resin etc. The silane coupling agent can be obtained by the catalyzed addition of HSiCl₃ to unsaturated alkenes with reactive groups in the presence of chloroplatinic acid followed by alcoholysis.

The amount of the silane coupling agent in the adhesive composition of the present invention is from 0.1 to 5.0 percent by weight, preferably, from 2.0 to 4.0 percent by weight.

### Optional Additives

Optional additives in the adhesive of the present invention are selected from one or more of the group consisting of a tackifier, a thickening agent, a flame retardant, a leveling agent and a thermal initiator.

Tackifiers can enhance the initial bonding force produced between an adhesive and a surface of a material to be bonded, and improve the bonding force. Tackifiers can be resins, such as rosin resins, terpene resins such as Rosin731D (from Hercules Chemical Company, Inc.), phenol-formaldehyde resins, rubbers, such as polybutadiene, polyisoprene, fatty alcohols, e.g., polyether polyols.

Thickening agents can improve the viscosity of an adhesive system, adjust the rheologic behavior, and thicken the adhesive system. Thickening agent may be selected from fumed silica, rubber, cellulose etc.

Flame retardants can keep an adhesive from igniting or slow down the spread of flame and restrain smoke effectively. Flame retardants can be halogen-free phosphates such as dimethyl methylphosphonate (e.g., Fyrol DMMP from MultiChem Inc.), polyether polyol phosphite, triphenyl phosphate, cyclic phosphate.

Leveling agents help to achieve a flat, smooth and even state when a liquid is coated on a substrate. Leveling agents can be polyacrylates, alkyl polysiloxanes, for example, BYK378 (from BYK (TONGLING) CO. LTD.).

Thermal initiators (organic peroxides) can achieve thermally-initiated curing. Organic peroxides can be peroxy(di)carbonates such as di(2-ethylhexyl) peroxydicarbonate, diacyl peroxides such as dilauroyl peroxide, dialkyl peroxides such as 2,5-dimethyl-2,5-di(tert-butylperoxy)hexane, 1-di(tert-butylperoxy)-3,3,5-trimethylhexane, peroxyesters such as tert-butyl peroxybenzoate. In the adhesive of the present invention one or more peroxide thermal initiators can be used. In the present invention, ester peroxides and alkyl peroxides are adopted to achieve thermal curing.

The adhesive composition of the present invention can be used for bonding or laminating various substrates such as various parts in display devices, particularly for assembling transparent parts, or bonding or laminating transparent substrates, and bonding or laminating transparent substrate and opaque substrate. For example, the transparent substrate is glass or a transparent plastic substrate etc, and the opaque substrate is a metal, opaque plastic, ceramic, stone, leather or a wood substrate. Most preferably, the adhesive of the invention is used for laminating glass substrates or for bonding two glass substrates.

### EXAMPLES

The present invention will be described in details in the following by way of examples. However, the protection scope of the present invention is not limited to these examples.

### Materials Used in the Examples

Urethane oligomer carrying (meth)acryloyloxy group 1-1:
Genomer 4188/EHA (from Rahn AG), average functionality: 1, Brookfield viscosity at 25° C.: 100000 to 140000 mPa·s, Tg=−17° C.;
Urethane oligomer carrying (meth)acryloyloxy group 1-2:
CN 9021 (from Sartomer Company, Inc.), average functionality: 2, Brookfield viscosity at 25° C.: 32009 mPa·s, Tg=−54° C.;
Multifunctional acrylate monomer 2:
Pentaerythritol tetraacrylate (multifunctional) (from Sartomer Company, Inc.)
Monofunctional acrylate monomer 3-1:
Hydroxypropyl methacrylate (from Sigma-Aldrich Co. LLC)
Monofunctional acrylate monomer 3-2:
2-(2-ethoxyethoxy) ethyl acrylate (from Sartomer Company, Inc.)
Photoinitiator 4-1:
2-hydroxyl-2-methyl-1-phenyl-1-propanone (from BASF company, Inc.)
Photoinitiator 4-2:
Diphenyl(2,4,6-trimethylbenzoyl)-phosphine oxide (from BASF company, Inc.)
Silane coupling agent 5:
Z-6011 (from Dow Corning Corporation);
Thermal initiator 6:
1,1-di(tert-butylperoxy)-3,3,5-trimethylhexane (from J&K Scientific Ltd.).

Other compounds used in the examples are all chemical pure agents that are commercially available.

### Test Methods and Conditions:

Test of UV curing: The adhesive composition between glass and PC is irradiated by UV light source with an irradiation power of 100 mW/cm² and a wavelength of 200 nm to 400 nm at room temperature.
Test of thermal curing: Away from the light, the adhesive composition between glass and PC is thermally cured in an oven (80° C., 1 hr).
Test of thermal impact: The adhesive is placed on glass/PMMA, and is subjected to thermal impact at high temperature and low temperature of −40˜70° C. for 1 hr respectively by a conventional thermal impact device, and the cycling time is 240 hrs.
Test of aging under high humidity: high humidity conditions (60° C.&90% RH, 240 hrs, glass/PMMA)
Test of measuring the bonding strength: The test aims at charactering the bonding strength imparted by the sufficiently cured adhesive to two substrates. The cured thickness is generally controlled to be 100 μm according to practical requirements. The substrates can be glass plates, polyester plates, or acrylic plates. The measurement device can be a universal tensile testing machine. The bonding strength measurement is conducted to the cued sample by pulling the two plates apart in the directions perpendicular to the surfaces by using a universal tensile testing machine. The strength (unit: MPa) is calculated by dividing the force needed to pull the two plates apart by the contact area of the two plates. In the present invention, after the adhesive composition between a glass plate and a PMMA plate cured by irradiating UV light having a UVA magnitude of 100 mW/cm² for 30 s, the bonding strength of the adhesive composition is measured.
Test of transparency: The transparency of the cured adhesive is measured by a UV spectrophotometer. The cured thickness of the adhesive is controlled to be 100 μm by two glass plates. The test method is in accordance with ASTM D1003-2007. After the adhesive composition between a glass plate and a glass plate is cured by irradiating UV light having a UVA magnitude of 100 mW/cm² for 30 s, the transparency of the adhesive composition is measured.
Test of elongation at break: The test method is in accordance with ASTM D638, and the moving speed of clamps is 50 mm/min

### Example 1

The adhesive composition 1 is formulated according to the following composition and method.

| | | |
|---|---|---|
| Component 1 | Urethane oligomer carrying | 65.0 percent by weight |
| | (meth)acryloyloxy group 1-2 | |
| Component 2 | Multifunctional acrylate | 1.0 percent by weight |
| | monomer 2 | |
| Component 3 | Monofunctional | 15.0 percent by weight |
| | acrylate monomer 3-1 | |
| | Monofunctional | 15.0 percent by weight |
| | acrylate monomer 3-2 | |
| Component 4 | Photoinitiator 4-1 | 2.0 percent by weight |
| | Photoinitiator 4-2 | 1.0 percent by weight |
| Component 5 | Silane coupling agent 5 | 1.0 percent by weight |

The percents of each component are percents by weight based on the total weight of the adhesive composition.

### Formulation Method

Each of the above components (100 g in total) are weighted into a plastic barrel having a capacity of 150 g, and dispersed at a high speed of from 2000 to 2400 rpm for 4 minutes using a SpeedMixer™ mixer from FlackTech Inc. Thereby, the adhesive composition 1 is obtained.

The obtained adhesive composition 1 was cured within 30 s in the test of UV curing, and can not be cured in the test of thermal curing. No bubbles occurred in the test of thermal impact, and no cracks occurred in the test of aging under high humidity. The bonding strength: >1.0 MPa, transparency: >92%, elongation at break: 300%.

### Example 2

The adhesive composition 2 is formulated according to the following composition and the formulation method of example 1.

| | | |
|---|---|---|
| Component 1 | Urethane oligomer carrying | 60.0 percent by weight |
| | (meth)acryloyloxy group 1-1 | |
| Component 2 | Multifunctional acrylate | 1.0 percent by weight |
| | monomer 2 | |
| Component 3 | Monofunctional acrylate | 17.0 percent by weight |
| | monomer 3-1 | |
| | monofunctional acrylate | 16.0 percent by weight |
| | monomer 3-2 | |
| Component 4 | Photoinitiator 4-1 | 2.0 percent by weight |
| | Photoinitiator 4-2 | 1.0 percent by weight |
| Component 5 | Silane coupling agent 5 | 1.0 percent by weight |
| Component 6 | Thermal initiator 6 | 2.0 percent by weight |

The percents of each component are percents by weight based on the total weight of the adhesive composition.

The obtained adhesive composition 2 was cured within 30 s in the test of UV curing, and can be cured in the test of thermal curing. No bubbles occurred in the test of thermal impact, and no cracks occurred in the test of aging under high humidity. The bonding strength: >1.0 MPa, transparency: >92%, elongation at break: 800%.

### Example 3

The adhesive composition 3 is formulated according to the following composition and the formulation method of example 1.

| | | |
|---|---|---|
| Component 1 | Urethane oligomer carrying | 60.0 percent by weight |
| | (meth)acryloyloxy group 1-1 | |
| Component 2 | Multifunctional acrylate | 1.0 percent by weight |
| | monomer 2 | |
| Component 3 | Monofunctional acrylate | 17.0 percent by weight |
| | monomer 3-1 | |
| | Monofunctional acrylate | 18.0 percent by weight |
| | monomer 3-2 | |
| Component 4 | Photoinitiator 4-1 | 2.0 percent by weight |
| | Photo initiator 4-2 | 1.0 percent by weight |
| Component 5 | Silane coupling agent 5 | 1.0 percent by weight |

The percents of each component are percents by weight based on the total weight of the adhesive composition.

The obtained adhesive composition 3 was cured within 30 s in the test of UV curing, and can not be cured in the test of thermal curing. No bubbles occurred in the test of thermal impact, and no cracks occurred in the test of aging under high humidity. The bonding strength: >1.0 MPa, transparency: >92%, elongation at break: 800%.

### Example 4

The adhesive composition 4 is formulated according to the following composition and the formulation method of example 1.

| | | |
|---|---|---|
| Component 1 | Urethane oligomer carrying | 50.0 percent by weight |
| | (meth)acryloyloxy group 1-1 | |
| Component 2 | Multifunctional acrylate | 2.0 percent by weight |
| | monomer 2 | |
| Component 3 | Monofunctional acrylate | 24.0 percent by weight |
| | monomer 3-1 | |
| | monofunctional acrylate | 20.0 percent by weight |
| | monomer 3-2 | |
| Component 4 | Photoinitiator 4-1 | 2.0 percent by weight |
| | Photoinitiator 4-2 | 1.0 percent by weight |
| Component 5 | Silane coupling agent 5 | 1.0 percent by weight |

The percents of each component are percents by weight based on the total weight of the adhesive composition.

The obtained adhesive composition 4 was cured within 30 s in the test of UV curing, and can not be cured in the test of thermal curing. No bubbles occurred in the test of thermal impact, and no cracks occurred in the test of aging under high humidity. The bonding strength: >0.8 MPa, transparency: >92%, elongation at break: 400%.

### Example 5

The adhesive composition 5 is formulated according to the following composition and the formulation method of example 1.

| | | |
|---|---|---|
| Component 1 | Urethane oligomer carrying | 50.0 percent by weight |
| | (meth)acryloyloxy group 1-1 | |
| Component 2 | Multifunctional acrylate | 1.0 percent by weight |
| | monomer 2 | |
| Component 3 | Monofunctional acrylate | 22.0 percent by weight |
| | monomer 3-1 | |
| | Monofunctional acrylate | 21.0 percent by weight |
| | monomer 3-2 | |
| Component 4 | Photoinitiator 4-1 | 2.0 percent by weight |
| | Photoinitiator 4-2 | 1.0 percent by weight |
| Component 5 | Silane coupling agent 5 | 1.0 percent by weight |
| Component 6 | Thermal initiator 6 | 2.0 percent by weight |

The percents of each component are percents by weight based on the total weight of the adhesive composition.

The obtained adhesive composition 5 was cured within 30 s in the test of UV curing, and can be cured in the test of thermal curing. No bubbles occurred in the test of thermal impact, and no cracks occurred in the test of aging under high humidity. The bonding strength: >1.2 MPa, transparency: >92%, elongation at break: 800%.

### Comparative Example 1

The comparative adhesive composition 1 is formulated according to the following composition and the method of example 1.

| | | |
|---|---|---|
| Component 1 | Urethane oligomer carrying | 35.0 percent by weight |
| | (meth)acryloylxy group 1-1 | |
| Component 2 | Multifunctional acrylate | 1.0 percent by weight |
| | monomer 2 | |
| Component 3 | Monofunctional acrylate | 35.0 percent by weight |
| | monomer 3-1 | |
| | Monofunctional acrylate | 24.0 percent by weight |
| | monomer 3-2 | |
| Component 4 | Photoinitiator 4-1 | 2.0 percent by weight |
| | Photoinitiator 4-2 | 1.0 percent by weight |
| Component 6 | Thermal initiator 6 | 2.0 percent by weight |

The percents of each component are percents by weight based on the total weight of the adhesive composition.

The obtained comparative adhesive composition 1 was cured within 30 s in the test of UV curing, and can be cured in the test of thermal curing. Bubbles occurred in the test of thermal impact, and no cracks occurred in the test of aging under high humidity. The bonding strength: >1.0 MPa, transparency: >92%, elongation at break: 70%.

The results show that when component 1-1 is 35.0 percent by weight, partial failure may occur due to aging, and elongation at break decreased to 70 percent remarkably.

### Comparative Example 2

The comparative adhesive composition 2 is formulated according to the following composition and the method of example 1.

| | | |
|---|---|---|
| Component 1 | Urethane oligomer carrying | 60.0 percent by weight |
| | (meth)acryloyloxy group 1-1 | |
| Component 2 | Multifunctional acrylate | 1.0 percent by weight |
| | monomer 2 | |
| Component 3 | Monofunctional acrylate | 17.0 percent by weight |
| | monomer 3-1 | |
| | Monofunctional acrylate | 17.0 percent by weight |
| | monomer 3-2 | |
| Component 4 | Photoinitiator 4-1 | 2.0 percent by weight |
| | Photoinitiator 4-2 | 1.0 percent by weight |
| Component 6 | Thermal initiator 6 | 2.0 percent by weight |

The percents of each component are percents by weight based on the total weight of the adhesive composition.

The obtained comparative adhesive composition 2 was cured within 30 s in the test of UV curing, and can be cured in the test of thermal curing. Bubbles occurred in the test of thermal impact, and cracks occurred slightly in the test of aging under high humidity. The bonding strength: >0.8 MPa, transparency: >92%, elongation at break: 800%.

The results show that when none silane coupling agent was added, failure may occur due to aging.

### Comparative Example 3

The comparative adhesive composition 3 is formulated according to the following composition and the method of example 1.

| | | |
|---|---|---|
| Component 1 | Urethane oligomer carrying | 60.0 percent by weight |
| | (meth)acryloyloxy group 1-1 | |
| Component 3 | Monofunctional acrylate | 18.0 percent by weight |
| | monomer 3-1 | |
| | Monofunctional acrylate | 16.0 percent by weight |
| | monomer 3-2 | |
| Component 4 | Photoinitiator 4-1 | 2.0 percent by weight |
| | Photoinitiator 4-2 | 1.0 percent by weight |
| Component 5 | Silane coupling agent 5 | 1.0 percent by weight |
| Component 6 | Thermal initiator 6 | 2.0 percent by weight |

The percents of each component are percents by weight based on the total weight of the adhesive composition.

The obtained comparative adhesive composition 3 was cured within 30 s in the test of UV curing, and can be cured in the test of thermal curing. Bubbles occurred in the test of thermal impact, and cracks occurred slightly in the test of aging under high humidity. The bonding strength: >1.0 MPa, transparency: >92%, elongation at break: 800%.

What is claimed is:

1. An adhesive composition comprising, based on the total weight of the adhesive composition:
(1) from 38.0 to 75.0 percent by weight of a urethane oligomer carrying (meth)acryloyloxy group;
(2) from 0.1 to 10.0 percent by weight of a multifunctional (meth)acrylate monomer;
(3) from 15.0 to 60.0 percent by weight of a monofunctional (meth)acrylate monomer;
(4) from 0.5 to 5.0 percent by weight of a photoinitiator;
(5) from 0.1 to 5.0 percent by weight of a silane coupling agent; and
(6) from 0 to 5.0 percent by weight of an additive, which is selected from one or more of the group consisting of a tackifier, a thickening agent, a flame retardant, a leveling agent and a thermal initiator.

2. The adhesive composition according to claim 1, wherein the urethane oligomer carrying (meth)acryloyloxy group has an average functionality of the (meth)acryloyloxy group of no more than 2.

3. The adhesive composition according to claim 1, wherein urethane oligomer carrying (meth)acryloyloxy group has a Tg of from −80° C. to 0° C. and the urethane oligomer carrying (meth)acryloyloxy group has a Brookfield viscosity at 25° C. of from 1000 mPa·s to 190000 mPa·s.

4. The adhesive composition according to claim 1, wherein the amount of the urethane oligomer carrying (meth)acryloyloxy group is from 40.0 to 65.0 percent by weight.

5. The adhesive composition according to claim 1, wherein the monofunctional (meth)acrylate monomer is selected from monofunctional alkyl(meth)acrylates, monofunctional alkenyl(meth)acrylates, and monofunctional heterocyclo(meth)acrylates,
wherein said alkyl is an alkyl group having from 1 to 20 carbon atoms, which may have one or more substituents; said alkenyl is an alkenyl group having from 2 to 20 carbon atoms, which may have one or more substituents; and said heterocyclo is a heterocyclic group having from 2 to 20 carbon atoms and having a heteroatom selected from nitrogen and oxygen, which may have one or more substituents; said one or more substituents may be selected from an alkyl group having from 1 to 20 carbon atoms, an alkyloxy group having from 1 to 20 carbon atoms, an aryloxy group having from 6 to 20 carbon atoms, a cycloalkyloxy group having from 3 to 20 carbon atoms, and hydroxyl.

6. The adhesive composition according to claim 1, wherein the monofunctional (meth)acrylate monomer is selected from methyl(meth)acrylate, ethyl(meth)acrylate, butyl(methyl)acrylate, 2-(2-ethoxyethoxy) ethyl acrylate, tetrahydrofurfury(meth)acrylate, lauryl acrylate, isooctyl acrylate, isodecyl acrylate, 2-phenoxyethyl acrylate, 2-ethylhexyl(meth)acrylate, isobornyl(meth)acrylate, dicyclopentenyloxyethyl(meth)acrylate, dicyclopentadienyl(meth)acrylate, 2-hydroxyethyl(meth)acrylate, 2-hydroxypropyl(meth)acrylate, 2-hydroxybutyl(meth)acrylate, caprolactone acrylate, morpholine(meth)acrylate and combinations thereof.

7. The adhesive composition according to claim 1, wherein the multifunctional (meth)acrylate monomer is selected from multifunctional alkyl(meth)acrylates, multifunctional alkenyl(meth)acrylates, and multifunctional heterocyclo(meth)acrylates,
wherein said alkyl is an alkyl group having from 1 to 20 carbon atoms, which may have one or more substituents; said alkenyl is an alkenyl group having from 2 to 20 carbon atoms, which may have one or more substituents; and said heterocyclo is a heterocyclic group having from 2 to 20 carbon atoms and having a heteroatom selected from nitrogen and oxygen, which may have one or more substituents; said one or more substituents may be selected from an alkyl group having from 1 to 20 carbon atoms, an alkyloxy group having from 1 to 20 carbon atoms, an aryloxy group having from 6 to 20 carbon atoms, a cycloalkyloxy group having from 3 to 20 carbon atoms, and hydroxyl.

8. The adhesive composition according to claim 1, wherein the multifunctional (meth)acrylate monomer is selected from hexanediol di(meth)acrylate, ethyleneglycol dimethacrylate, trimethylolpropane triacrylate, pentaerythritol tetraacrylate and combinations thereof.

9. The adhesive composition according to claim 1, wherein the amount of the monofunctional (meth)acrylate monomer is from 20.0 to 45.0 percent by weight, and the amount of the multifunctional (meth)acrylate monomer is from 2.0 to 8.0 percent by weight.

10. The adhesive composition according to claim 1, wherein the photoinitiator is selected from 2,2-dimethoxy-1,2-diphenylethan-1-one,
trimethylbenzoyl diphenylphosphine oxide, 1-hydroxycyclohexyl benzophenone, 2-methyl-1-[4-(methylthio)phenyl]-2-morpholinopropan-1-one,
ethyl-2,4,6-trimethylbenzoylphenylphosphinate, 2-hydroxyl-2-methyl-1-phenyl-1-propanone, diphenyl(2,4,6-trimethylbenzoyl)-phosphine oxide and combinations thereof, and the amount of the photo initiator is from 2.0 to 4.0 percent by weight.

11. A cured product of the adhesive of claim 1.

12. A display device comprising cured reaction products of the adhesive composition of claim 1.

13. Bonded or laminated parts in display devices comprising cured reaction products of the adhesive composition of claim 1.

14. Transparent parts comprising cured reaction products of the adhesive composition of claim 1.

15. The adhesive composition according to claim 1, wherein the photoinitiator is a UV photoinitiator.
